(19) United States
(12) Patent Application Publication
(10) Pub. No.: US 2005/0170100 A1
(43) Pub. Date: Aug. 4, 2005

(54) Process for applying an opaque, corrosion resistant, 100% solids, UV curable finish to parts for underhood use in motor vehicles

(76) Inventor: Sally Judith Weine Ramsey, Tallmadge, OH (US)

Correspondence Address: WILSON SONSINI GOODRICH & ROSATI, 650 PAGE MILL ROAD, PALO ALTO, CA, 943041050, US

(21) Appl. No.: 10/771,867

(22) Filed: Feb. 4, 2004

(51) Int. Cl. B05D 5/00

(52) U.S. Cl. 427/458

(57) ABSTRACT

A process for applying an opaque, corrosion resistant, 100% solids, UV curable finish to parts for underhood use in motor vehicles with the steps of: 1. Prepare a UV curable, 100% solids, opaque, corrosion resistant coating. 2. Apply the coating to underhood motor vehicle parts by the use of HVLP or electrostatic spray. 3. Cure the coating with single or a combination of ultra-violet lights containing an array ultraviolet frequencies sufficient to provide both a surface cure and to penetrate the opaque pigment to provide curing and adhesion to the substrate. Lights must be configured in such a way that every surface of the parts must be struck by the necessary array of frequencies of light. Use no heat. 4. Parts are ready to handle or ship immediately. This process cuts the time, energy, and space needed to coat and cure opaque, corrosion resistant parts. It also eliminates the need for pollution control technology.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of corrosion resistant coatings and more specifically to a process for applying an opaque, corrosion resistant, 100% solids, UV curable finish to parts for underhood use in motor vehicles. It is very important to the durability of a motor vehicle that corrosion of underhood components be prevented. In addition, for the desirability of a vehicle, components should have an attractive appearance. Thus it is important that underhood parts be coated with a corrosion preventative, visually acceptable, opaque coating. In addition, the coating should be as environmentally friendly as possible, for the welfare of both business and the general population. Up to this point, coatings used for this purpose have been either powders or waterborne liquids. Powder coatings require a large amount of time, energy, and space to be properly cured. Waterbornes often have similar requirements and also show inferior performance. A corrosion resistant UV cured, opaque coating equals or exceeds the performance of powders or waterbornes for underhood use while cutting production time and space requirements as well as using up to 80% less energy.

### BRIEF SUMMARY OF THE INVENTION

The primary object of the invention is To provide energy savings of up to 80%.

Another object of the invention is To provide cost savings.

Another object of the invention is To utilize less space.

A further object of the invention is To eliminate the need for air pollution control technology.

Another object is to produce visually acceptable parts.

A further object is to equal or exceed previous performance of parts as to corrosion resistance.

Yet another object of the invention is To cut production time.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a process for applying an opaque, corrosion resistant, 100% solids, UV curable finish to parts for underhood use in motor vehicles comprising the steps of.
1. Prepare a UV curable, 100% solids, opaque, corrosion resistant coating.
2. Apply the coating to underhood motor vehicle parts by the use of HVLP or electrostatic spray.
3. Cure the coating with a combination of ultra-violet lights containing an array ultraviolet frequencies sufficient to provide both a surface cure and to penetrate the opaque pigment to provide curing and adhesion to the substrate. Lights must be configured in such a way that every surface of the parts must be struck by the necessary array of frequencies of light. Use no post cure.
4. Parts are ready to handle or ship.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a flow chart of the operations that comprise the method. FIG. 2 is an illustration of the components required for an opaque, corrosion resistant, UV curable coating. FIG. 3 is an illustration of how the coating may be applied. FIG. 4 is an illustration of the cure of the coating. FIG. 5 is an illustration of the immediate availability of shipping and handling of underhood automobile parts.

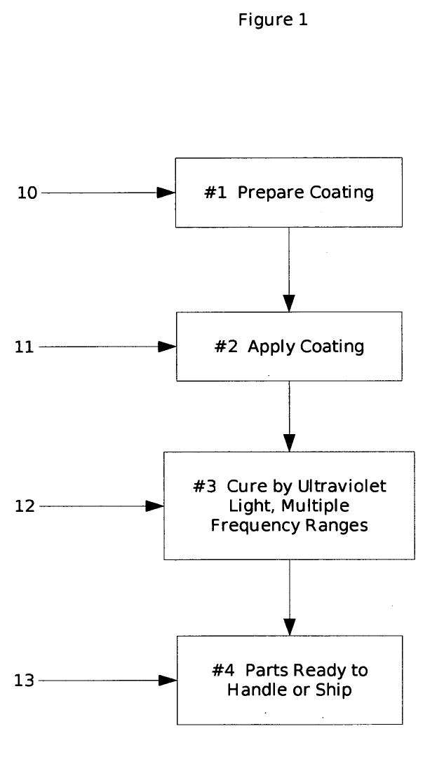

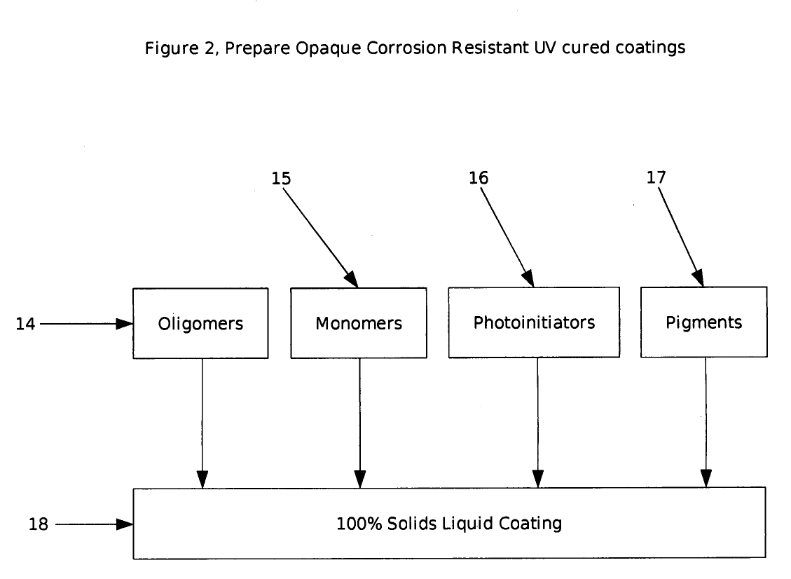

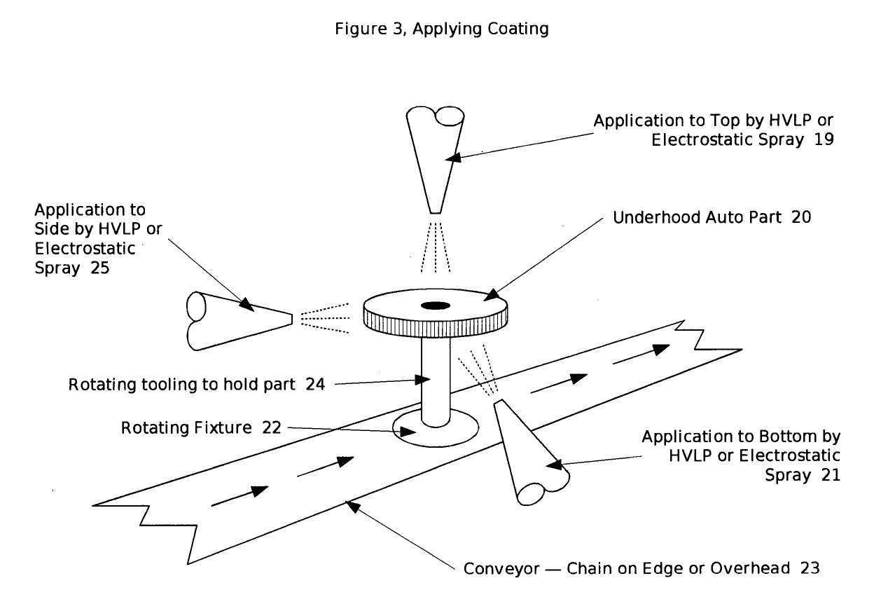

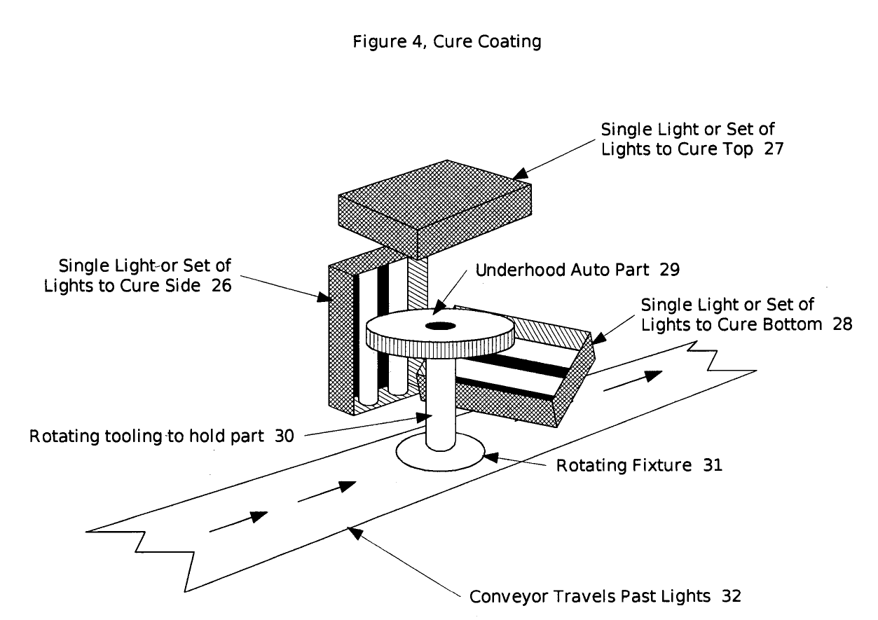

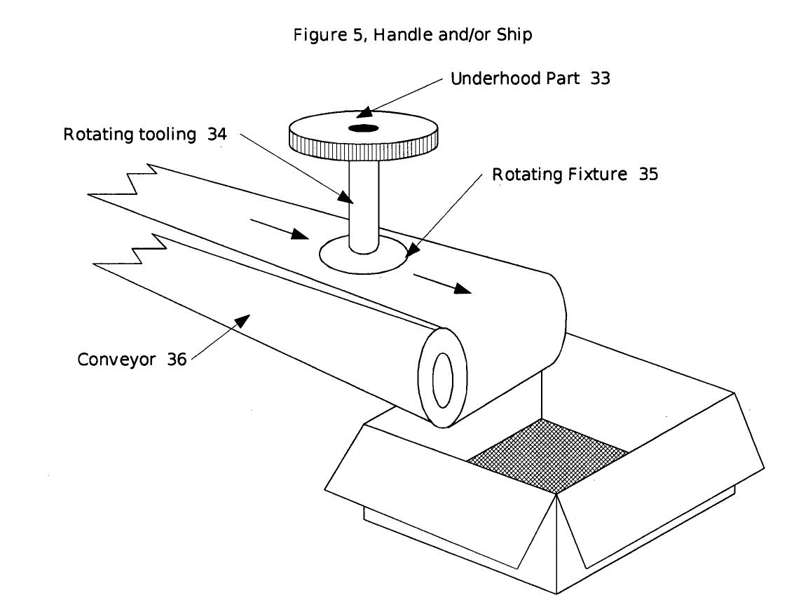

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Previous technology involves the application of conventional opaque, corrosion resistant coatings to provide a finish to underhood parts of motor vehicles. These coatings have, in the past been solventborne. More recently, in the interest of lower emissions, these coatings have been waterborne or powder. Referring to FIG. 3, numbers 19 through 25 are all taken from previous technologies. All of these technologies require long curing times and larger amounts of space. In addition, large amounts of energy are often required. A system for destruction of volatile solvents involved in curing may also be required. With powder, a system for collection of particulates may be required. With this process, emissions can be lower still, while saving space, time and energy and requiring no final system for pollution control.

It has been assumed that opaque coatings could not be well enough cured by UV radiation to fully penetrate to the base substrate and to meet the quality demands of the automotive industry. By the combination of a properly formulated 100% solids UV curable coating, FIG. 2, and appropriate frequencies of light, FIG. 4, 26-28, these results may be obtained. A 100% solids UV curable coating is one that contains no added solvents or water which would require evaporation or to be driven off by heat. As a result, there are no emissions from solvent. No space is required for large ovens. No time is required for evaporation or baking. Energy use is up to 80% lower, because heating is unnecessary. Such a coating is cured by exposure to ultra-violet light, instead of heat or exposure to air. Since this curing process is almost instantaneous, requiring an average of 1.5 seconds per light, (FIG. 4), both time and energy are conserved. Curing lights used may be high pressure mercury lamps. mercury lamps doped with gallium or iron, or in combination as required. Lamps may be powered by direct application of voltage, by microwaves or by radiowaves.

Referring to FIG. 2, a coating is prepared using a mixture of photoinitiators sufficent to encompass all necessary frequencies of light. These are used to work with the pairs of lights in FIG. 4, 26-28. Photoinitiators are componds that absorb ultra-violet light and use the energy of that light to promote the formation of a dry layer of coating. In addition, the coating must contain a combination of oligomer and monomers such that necessary corrosion resistance is obtained. Oligomers are molecules containing several repeats of a single molecule. Monomers are substances containing single molecules that can link to oligomers and to each other. Proper choice of monomer also promotes adhesion to a properly prepared surface.

Automotive parts may be properly cleaned and prepared using conventional technology. Referring to FIG. 3 the coating is then applied using either HVLP or electrostatic technology, this is the same technology used to apply conventional coatings. Alternative applications might involve dipping, flow, or curtain coating of parts.

Referring to FIG. 4, the coating is then exposed to single UV lights or combinations ov UV lights array d in such a way that all surfaces are cured. This process involves exposure of all coated surfaces to UV light. This may be accomplished by a combination of rotation, 30,31 and configuration of lights, 26-28. Parts are moved quickly through lights using a continuous conveyor, 32. An alternative method would be to index the parts for a controlled period of time in the array of lights. Either method would correspond to FIG. 4. Whether continuous or indexed, this process can be measured in terms of seconds. No addition of heat is necessary.

Referring to FIG. 5, parts are then immediately ready to handle and/or ship in a way that is amenable to just-in-time manufacturing methods. No post cure is necessary.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A process for applying an opaque, corrosion resistant, 100% solids, UV curable finish to parts for underhood use in motor vehicles comprising the steps of:
1. Prepare a UV curable, 100% solids, opaque, corrosion resistant coating.
2. Apply the coating to underhood motor vehicle parts by the use of HVLP or electrostatic spray, or by other means.
3. Cure the coating with single or combinations of ultra-violet lights containing an array ultraviolet frequencies sufficient to provide both a surface cure and to penetrate the opaque pigment to provide curing and adhesion to the substrate. Lights must be configured in such a way that every surface of the parts must be struck by the necessary array of frequencies of light. Use no post cure.
4. Parts are ready to handle or ship.
